(19) United States
(12) Patent Application Publication
(10) Pub. No.: US 2007/0182623 A1
(43) Pub. Date: Aug. 9, 2007

(54) Method and apparatus for on-vehicle calibration and orientation of object-tracking systems

(76) Inventors: Shuqing Zeng, Sterling Heights, MI (US); Mark Jonathan Wolski, Warren, MI (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/347,009

(22) Filed: Feb. 3, 2006

(51) Int. Cl. G01S 7/40

(52) U.S. Cl. 342/174; 342/95; 342/70

(57) ABSTRACT

The invention includes a method and associated apparatus to perform on-line fine alignment of multiple object-locating sensors. Up to three geometrical parameters, two for location, one for bearing alignment, can be computed for each sensor based upon object trajectories. The method includes establishing initial values for alignments of each sensor relative to a vehicle coordinate system, and determining positions for a target object for each of the object-locating sensors. A trajectory is determined for the target object. The alignment of each of the object-locating sensors is adjusted relative to the coordinate system for the vehicle based upon the trajectory for the target object.

### TECHNICAL FIELD

This invention pertains generally to object-tracking systems, and more specifically to measurement systems associated with object-tracking systems related to vehicle operation.

### BACKGROUND OF THE INVENTION

Modern vehicles may be equipped with various sensing devices and systems that assist a vehicle operator in managing vehicle operation. One type of sensing system is intended to identify relative locations and trajectories of other vehicles and other objects on a highway. Exemplary systems employing sensors which identify relative locations and trajectories of other vehicles and other objects on the highway include collision-avoidance systems and adaptive cruise control systems.

Sensor systems installed on vehicles are typically calibrated during the vehicle assembly process. However, there is an ongoing concern that sensor orientation and signal output may drift during the life of the sensor, such that the orientation of the sensor relative to the vehicle is changed. When the sensor orientation changes or drifts, measurements become skewed relative to the vehicle. When there are multiple sensors, the concern is further complicated in that outputs between the sensors become skewed.

In order for the data from various sensors to be successfully combined to produce a consistent object map, i.e. locus and trajectory of a remote object, the sensor data need to be correctly registered. That is, the relative locations of the sensors, and the relationship between their coordinate systems and the vehicle coordinate system, typically oriented to the vehicle frame, needs to be determined. When a system fails to correctly account for registration errors, a result may comprise a mismatch between a compiled object map (sensor data) and ground truth. Examples include an overstated confidence in location and movement of a remote object (or target) such as a vehicle, and, unnecessary multiplicity of tracks in an on-board tracking database, including multiple tracks corresponding to a single remote object.

Therefore, there is a need to align each individual sensor with an accuracy comparable to its intrinsic resolution, e.g., having an alignment accuracy of 0.1 degree for a sensor having an azimuth accuracy on an order of 0.1 degree. Precision sensor mounting is vulnerable to drift during the vehicle's life and difficult to maintain manually.

There is a need to ensure that signals output from sensors are aligned and oriented with a fixed coordinate system to eliminate risk of errors associated with skewed readings. Therefore, it is desirable to have a sensor system that automatically aligns sensor output to a reference coordinate system. It is also desirable to align the sensors using a tracked object as a reference, in order to facilitate regular, ongoing alignments, to improve sensor accuracy and reduce errors associated with drift.

### SUMMARY OF THE INVENTION

This invention presents a method and apparatus by which object-locating sensors mounted on a vehicle can be aligned to high precision with respect to each other. The invention includes a method and associated apparatus to automatically perform on-line fine alignment of multiple sensors. Up to three geometrical parameters, two for location, one for bearing alignment, can be computed for each sensor based upon object trajectories.

Thus, in accordance with the present invention, an article of manufacture is provided, comprising a storage medium having a computer program encoded therein for effecting a method to align one of a plurality of object-locating sensors mounted on a vehicle. Executing the program accomplishes a method which includes establishing initial values for alignments of each of the object-locating sensors relative to a coordinate system for the vehicle, and determining a plurality of positions for a target object for each of the object-locating sensors. A trajectory is determined for the target object. The alignment of each of the object-locating sensors is adjusted relative to the coordinate system for the vehicle based upon the trajectory for the target object.

Another aspect of the invention comprises establishing initial values for alignments of each of the object-locating sensors using a manual calibration process.

Another aspect of the invention comprises determining positions of the target object for each of the object-locating sensors at a series of substantially time-coincident moments occurring over a period of time, including determining a plurality of matched positions of the target object.

A further aspect of the invention comprises adjusting the alignment of each of the object-locating sensors relative to the coordinate system for the vehicle based upon the trajectory for the target object, including determining matched positions of the target object at a series of substantially time-coincident moments occurring over a period of time, and estimating corrections using a least-squares method. An angular alignment of the sensor is determined relative to the vehicle coordinate system. Each matched position of the target object comprises a fused position of the target object, and, a time-coincident sensor-observed position of the target object.

Another aspect of the invention comprises estimating a plurality of corrections by iteratively executing a least-squares estimation equation.

Another aspect of the invention comprises incrementally iteratively correcting the angular alignment of the sensor relative to the vehicle coordinate system.

Another aspect of the invention consists of the object-locating sensors and subsystem, which can comprise a short-range radar subsystem, and long-range radar subsystem, and a forward vision subsystem.

Another aspect of the invention comprises a system for locating a target object. The system comprises a vehicle equipped with a control system operably connected to a plurality of object-locating sensors each operable to generate a signal output characterizing location of the target object in terms of a range, a time-based change in range, and an angle measured from a coordinate system oriented to the vehicle. The control system operates to fuse the plurality of signal outputs of the object-locating sensors to locate the target object. The control system includes an algorithm for aligning the signal outputs of each of the object-locating sensors.

These and other aspects of the invention will become apparent to those skilled in the art upon reading and understanding the following detailed description of the embodiments.

### BRIEF DESCRIPTION OF THE DRAWINGS

The invention may take physical form in certain parts and arrangement of parts, the preferred embodiment of which will be described in detail and illustrated in the accompanying drawings which form a part hereof, and wherein:

FIG. 1 is a schematic diagram of a vehicle system, in accordance with the present invention; and,

FIGS. 2 and 3 are schematic diagrams of a control system, in accordance with the present invention.

### DETAILED DESCRIPTION OF THE PREFERRED EMBODIMENT

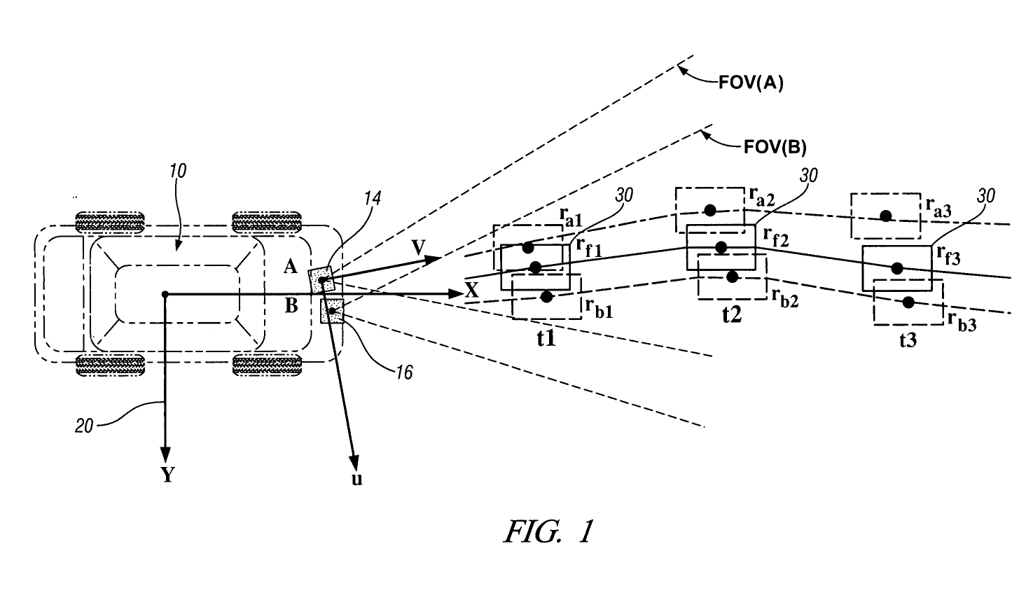

Referring now to the drawings, wherein the showings are for the purpose of illustrating the invention only and not for the purpose of limiting the same, FIG. 1 shows a vehicle system 10 which has been constructed in accordance with an embodiment of the present invention.

The exemplary vehicle comprises a passenger vehicle intended for use on highways, although it is understood that the invention described herein is applicable on any vehicle or other system seeking to monitor position and trajectory of remote vehicles and other objects. The vehicle includes a control system containing various algorithms and calibrations which it is operable to execute at various times. The control system is preferably a subset of an overall vehicle control architecture which is operable to provide coordinated vehicle system control. The control system is operable to monitor inputs from various sensors, synthesize pertinent information and inputs, and execute algorithms to control various actuators to achieve control targets, including such parameters as collision avoidance and adaptive cruise control. The vehicle control architecture comprises a plurality of distributed processors and devices, including a system controller providing functionality such as antilock brakes, traction control, and vehicle stability.

Each processor is preferably a general-purpose digital computer generally comprising a microprocessor or central processing unit, read only memory (ROM), random access memory (RAM), electrically programmable read only memory (EPROM), high speed clock, analog-to-digital (A/D) and digital-to-analog (D/A) circuitry, and input/output circuitry and devices (I/O) and appropriate signal conditioning and buffer circuitry. Each processor has a set of control algorithms, comprising resident program instructions and calibrations stored in ROM and executed to provide the respective functions of each computer.

Algorithms described herein are typically executed during preset loop cycles such that each algorithm is executed at least once each loop cycle. Algorithms stored in the non-volatile memory devices are executed by one of the central processing units and are operable to monitor inputs from the sensing devices and execute control and diagnostic routines to control operation of a respective device, using preset calibrations. Loop cycles are typically executed at regular intervals, for example each 3, 6.25, 15, 25 and 100 milliseconds during ongoing engine and vehicle operation. Alternatively, algorithms may be executed in response to occurrence of an event.

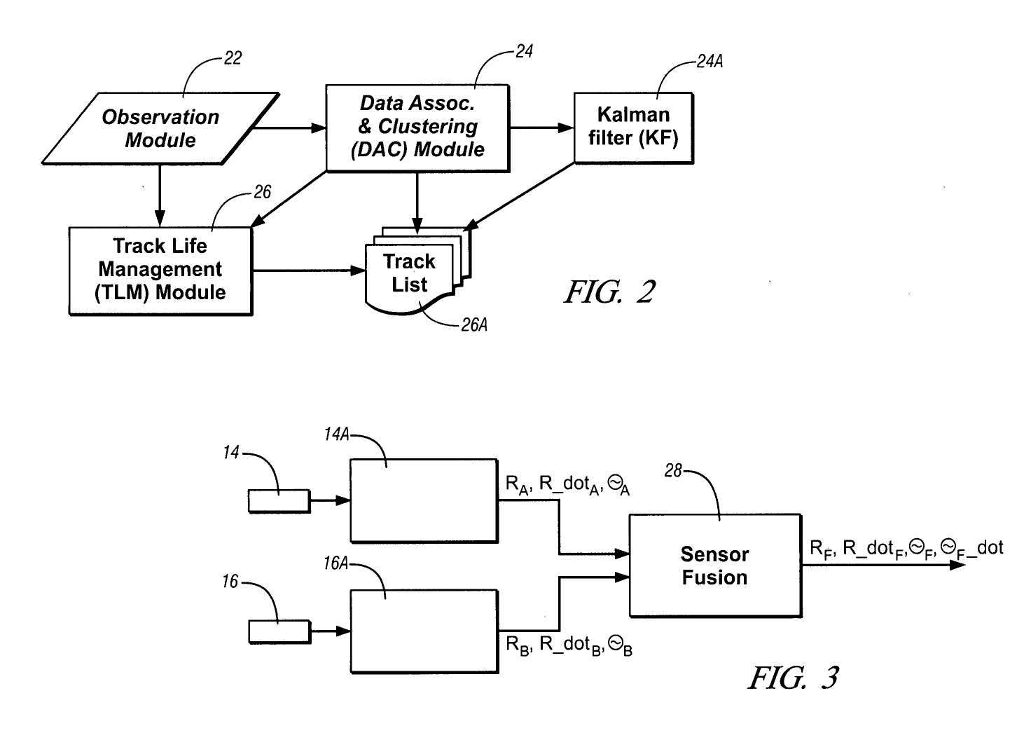

Referring now to FIG. 2 and 3, the exemplary vehicle 10 generally includes a control system having an observation module 22, a data association and clustering (DAC) module 24 that further includes a Kalman filter 24a, and a track life management (TLM) module 26 that keeps track of a track list 26a comprising of a plurality of object tracks. More particularly, the observation module consists of sensors 14, 16, their respective sensor processors, and the interconnection between the sensors, sensor processors, and the DAC module. The exemplary sensing system preferably includes object-locating sensors comprising at least two forward-looking range sensing devices 14, 16 and accompanying subsystems or processors 14a, 16a. The object-locating sensors may include a short-range radar subsystem, a long-range radar subsystem, and a forward vision subsystem. The object-locating sensing devices may include any range sensors, such as FM-CW radars, (Frequency Modulated Continuous Wave), pulse and FSK (frequency shift keying) radars, and Lidar (Light detection and ranging) devices, and ultrasonic devices which rely upon effects such as Doppler-effect measurements to locate forward objects. The possible object-locating devices include charged-coupled devices (CCD) or complementary metal oxide semi-conductor (CMOS) video image sensors, and other known camera/video image processors which utilize digital photographic methods to ‘view’ forward objects. Such sensing systems are typically employed for detecting and locating objects in automotive applications, useable with systems including, e.g., adaptive cruise control, collision avoidance, pre-crash safety, and side-object detection. The exemplary vehicle system may also include a global position sensing (GPS) system. These sensors are preferably positioned within the vehicle 10 in relatively unobstructed positions relative to a view in front of the vehicle. It is also appreciated that each of these sensors provides an estimate of actual location or condition of a targeted object, wherein said estimate includes an estimated position and standard deviation. As such, sensory detection and measurement of object locations and conditions are typically referred to as “estimates.” It is further appreciated that the characteristics of these sensors are complementary, in that some are more reliable in estimating certain parameters than others. Conventional sensors have different operating ranges and angular coverages, and are capable of estimating different parameters within their operating range. For example, radar sensors can usually estimate range, range rate and azimuth location of an object, but is not normally robust in estimating the extent of a detected object. A camera with vision processor is more robust in estimating a shape and azimuth position of the object, but is less efficient at estimating the range and range rate of the object. Scanning type Lidars perform efficiently and accurately with respect to estimating range, and azimuth position, but typically cannot estimate range rate, and is therefore not accurate with respect to new object acquisition/recognition. Ultrasonic sensors are capable of estimating range but are generally incapable of estimating or computing range rate and azimuth position. Further, it is appreciated that the performance of each sensor technology is affected by differing environmental conditions. Thus, conventional sensors present parametric variances, but more importantly, the operative overlap of these sensors creates opportunities for sensory fusion.

Each object-locating sensor and subsystem provides an output typically characterized in terms of range, R, time-based change in range, R_dot, and angle, Θ, preferably measuring from a longitudinal axis of the vehicle. An exemplary short-range radar subsystem has a field-of-view (‘FOV’) of 160 degrees and a maximum range of thirty meters. An exemplary long-range radar subsystem has a field-of-view of 17 degrees and a maximum range of 220 meters. An exemplary forward vision subsystem has a field-of-view of 45 degrees and a maximum range of fifty (50) meters. For each subsystem the field-of-view is preferably oriented around the longitudinal axis of the vehicle 10. The vehicle is preferably oriented to a coordinate system, referred to as an XY-coordinate system 20, wherein the longitudinal axis of the vehicle 10 establishes the X-axis, with a locus at a point convenient to the vehicle and to signal processing, and the Y-axis is established by an axis orthogonal to the longitudinal axis of the vehicle 10 and in a horizontal plane, which is thus parallel to ground surface.

As shown in FIG. 3, the illustrated observation module 22 includes first sensor 14 located and oriented at a discrete point A on the vehicle, first signal processor 14a, second sensor 16 located and oriented at a discrete point B on the vehicle, and second signal processor 16a. The first processor 14a converts signals received from the first sensor 14 to determine range (R_{A}), a time-rate of change of range (R_dot_{A}), and azimuth angle (Θ_{A}) estimated for each measurement in time of target object 30. Similarly, the second processor 16a converts signals received from the second sensor 16 to determine a second set of range (R_{B}), range rate (R_dot_{B}), and azimuth angle (1_{B}) estimates for the object 30.

The preferred DAC module 24 includes a controller 28, wherein an algorithm and associated calibration (not shown) is stored and configured to receive the estimate data from each of the sensors A, B, to cluster data into like observation tracks (i.e. time-coincident observations of the object 30 by sensors 14, 16 over a series of discrete time events), and to fuse the clustered observations to determine a true track status. It is understood that fusing data using different sensing systems and technologies yields robust results. Again, it is appreciated that any number of sensors can be used in this technique. However, it is also appreciated that an increased number of sensors results in increased algorithm complexity, and the requirement of more computing power to produce results within the same time frame. The preferred controller 28 is housed within the host vehicle 10, but may also be located at a remote location. In this regard, the preferred controller 28 is electrically coupled to the sensor processors 14a, 16a, but may also be wirelessly coupled through RF, LAN, infrared or other conventional wireless technology. The TLM module 26 is configured to receive fused data of liked observations, and store the fused observations in a list of tracks 26a.

The invention, as now described, comprises a method to determine an alignment of each object-locating sensor relative to the XY-coordinate system 20 for the vehicle, executed as one or more algorithms in the aforementioned control system. The method comprises establishing initial values for the alignments of each of the object-locating sensors relative to the XY-coordinate system for the vehicle, for each sensor. A plurality of positions for target object 30 is determined, as measured by each of the object-locating sensors, and trajectories are thus determined. A fused trajectory for the target object is determined, based upon the aforementioned trajectories. Alignment of each of the object-locating sensors is adjusted relative to the XY-coordinate system for the vehicle based upon the fused trajectory for the target object. This is now described in greater detail.

The schematic illustration of FIG. 1 includes the aforementioned object-locating sensors 14, 16 mounted on the exemplary vehicle at positions A and B, preferably mounted at the front of the vehicle 10. A single target 30 moves away from the vehicle, wherein t₁, t₂, and t₃ denote three consecutive time frames. Lines rₐ₁-raₐ₂-rₐ₃, r_{f1}-r_{f2}-r_{f3}, and r_{b1}-r_{b2}-r_{b3} represent, respectively, the locations of the target measured by first sensor 14, fusion processor, and second sensor 16 at times t₁, t₂, and t₃, measured in terms of R_{A}, R_{B}, R_dOt_{A}, R_dot_{B}, Θ_{A}, Θ_{B}, using sensors 14, 16, located at points A, B.

The trajectory fusion process comprises a method and apparatus for fusing tracking data from a plurality of sensors to more accurately estimate a location of an object. An exemplary target tracking system and method utilizing a plurality of sensors and data fusion increases the precision and certainty of system measurements above that of any single system sensor. Sensor coverage is expanded by merging sensor fields-of-view and reducing capture/recapture time of objects, thus decreasing a likelihood of producing false positives and false negatives. The exemplary target tracking and sensor fusion system can estimate a condition of at least one object. The system includes a first sensor configured to determine a first estimate of a condition of the object, and a second sensor configured to determine a second estimate of the condition. The system includes a controller communicatively coupled to the sensors, and configured to determine a third estimate of the condition. The third estimate is based in part on the first and second estimates, and each of the first and second estimates includes a measured value and a standard deviation value. The third estimate presents a calculated value and a standard deviation less than each of the first and second standard deviations. A computer program executed by the controller is configured to receive initial estimate data of at least one condition from the sensors, e.g. position, range, or angle, and apply the fusion algorithm to the initial estimate data, so as to determine a state estimate for the condition. The state estimate presents a higher probability and smaller standard deviation than the initial estimate data. The sensor fusion algorithm is applied to a vehicle having like or dissimilar sensors, which increases the robustness of object detection. In this configuration, applications, such as full speed adaptive cruise control (ACC), automatic vehicle braking, and pre-crash systems can be enhanced.

The aforementioned fusion process permits determining position of a device in the XY-coordinate system relative to the vehicle. The fusion process comprises measuring forward object 30 in terms of R_{A}, R_{B}, R_dot_{A}, R_dot_{B}, Θ_{A}, Θ_{B}, using sensors 14, 16, located at points A, B. A fused location for the forward object 30 is determined, represented as R_{F}, R_dot_{F}, Θ_{F}, Θ_dOt_{F}, described in terms of range, R, and angle, Θ, as previously described. The position of forward object 30 is then converted to parametric coordinates relative to the vehicle's XY-coordinate system. The control system preferably uses fused track trajectories (Line r_{f1}, r_{f2}, r_{f3}), comprising a plurality of fused objects, as a benchmark, i.e., ground truth, to estimate true sensor positions for sensors 14, 16. As shown in FIG. 1, the fused track's trajectory is given by object 30 at time series t₁, t₂, and t₃. Using a large number of associated object correspondences, such as {(rₐ₁, r_{f1}, r_{b1}), (rₐ₂, r_{f2}, r_{b2}), (rₐ₃, r_{f3}, r_{b3})} true positions of sensors 14 and 16 at points A and B, respectively, can be computed to minimize residues, preferably employing a known least-squares calculation method. In FIG. 1, the items designated as rₐ₁, rₐ₂, and rₐ₃ denote an object map measured by the first sensor 14. The items designated as r_{b1}, r_{b2}, and r_{b3} denote an object map observed by the second sensor 16.

With reference now to FIG. 2, the fused track is preferably calculated and determined in the sensor fusion block 28 of FIG. 3. The process of sensor registration comprises determining relative locations of the sensors 14, 16 and the relationship between their coordinate systems and the frame of the vehicle, identified by the XY-coordinate system, which is now described. Registration for single object sensor 16 is now described. All object sensors are preferably handled similarly. For object map compensation the sensor coordinate system or frame, i.e. the UV-coordinate system, and the vehicle coordinate frame, i.e. the XY-coordinate system, are preferably used. The sensor coordinate system (u, v) is preferably defined as follows: The origin is at the center of the sensor; the v-axis is along longitudinal direction (bore-sight) and u-axis is normal to v-axis and points to the right. The vehicle coordinate system, as previously described, is denoted as (x, y) wherein x-axis denotes a vehicle longitudinal axis and y-axis denotes the vehicle lateral axis.

To transform a point, representing a time-stamped location of a target object 30 located on the sensor coordinate system (u, v) to the vehicle coordinate system (x, y) the following actions are executed as algorithms and calibrations in the vehicle control system, as described hereinabove, starting with Eq. 1:
r=Rq+r₀ (1)

wherein r=(x, y), q=(u, v), R is a 2-D rotation and r₀=(x₀, y₀) is the position of the sensor center in the vehicle frame.

Initially R and r₀ are typically determined by a manual calibration process in the vehicle assembly plant. During operation, this information is corrected by an incremental rotation δR and translation δr₀ so that the new rotation and translation become as shown in Eqs. 2 and 3, below:
R′=ERR, and, (2)
r′₀=r₀+δr₀ (3)

wherein R is written as:

$$R = [ \begin{matrix}cos ψ & sin ψ \\ - sin ψ & cos ψ\end{matrix} ] .$$

The value ψ denotes the specific sensor's angular alignment with respect to the vehicle frame, i.e. the orientation of the UV-coordinate system relative to the XY-coordinate system. Since the alignment corrections are typically small, the incremental rotation δR can be approximated by Eq. 4, below:
δR=I+ε (4)

wherein:

$$ɛ = [ \begin{matrix}0 & δ ψ \\ - δψ & 0\end{matrix} ]$$

and δψ denotes correction of the alignment angle.

A correction of the object position is given by Eq. 5:
Δr=r′−r=R′q+r′₀−Rq−r₀ (5)

Equations 1-5, above, are combined to yield Eq. 6:
Δr=δRRq+δr₀−Rq=ε(r−r₀)+δr₀. (6)

Eq. 6 is rewritten in component form, as Eq. 7:

$$Δ r = [ \begin{matrix}Δ x \\ Δ y\end{matrix} ] = A β = [ \begin{matrix}1 & 0 & - ( y - {y}_{0} ) \\ 0 & 1 & x - {x}_{0}\end{matrix} ] [ \begin{matrix}δ {x}_{0} \\ δ {y}_{0} \\ δψ\end{matrix} ] \qquad ( 7 )$$

wherein:
δr₀=(δx₀, δy₀)^{T},
rᵢ=(xᵢ, yᵢ)^{T},
r₀=(δx₀, δy₀)^{T}, and
β=(δx₀, δy₀, δψ)^{T}.

Correction of the sensor position is determined by using matched objects. Results calculated in Eq. 7 provide a model by which unknown corrections β are estimated by minimizing a respective χ² function using a large number of matched objects.

As an example, assume the matched object denoted by {(r_{fi}, rₐᵢ)|i=1, . . . , N}, wherein r_{fi} and rₐᵢ denote the positions of the i-th fused object and the sensor-observed object, respectively.

The χ² function is minimized to Eq. 8:

$${χ}^{2} = {\sum }_{i = 1}^{N} {( Δ {r}_{i} - {A}_{i} β )}^{T} W ( Δ {r}_{i} - {A}_{i} β ) \qquad ( 8 )$$

wherein the sum is taken over all matched object pairs (r_{fi}, rₐᵢ), Δrᵢ=r_{fi}−rₐᵢ and W=diag{w₁, w₂, . . . , w_{N}} is a weight matrix. Here wᵢ is a function of object range (i.e., w₁=f(rᵢ)) such that distant matched objects are attributed larger weighting factors than nearby matched objects. The correction β is found by the least square estimation procedure. The solution is shown in Eq. 9, below:

$$β = {( {\sum }_{i = 1}^{N} {A}_{i}^{T} {W}^{- 1} {A}_{i} )}^{†} ( {\sum }_{i = 1}^{N} {A}_{i}^{T} {W}^{- 1} Δ {r}_{i} ) \qquad ( 9 )$$

wherein X^{†} denotes a pseudoinverse of X.

Therefore, the incremental correction equations of the sensor position (R and r₀) comprise Eq. 10 and 11, below:

$$\begin{matrix}{R}^{′} = R + ɛ R = R + η [ \begin{matrix}0 & δψ \\ - δψ & 0\end{matrix} ] R & ( 10 ) \\ {r}_{0}^{′} = {r}_{0} + η [ \begin{matrix}δ {x}_{0} \\ δ {y}_{0}\end{matrix} ] & ( 11 )\end{matrix}$$

wherein η is a learning factor, typically a small positive number (e.g., η=0.01) for updating the sensor position iteratively through time. A large value for η may help the algorithm quickly converge to a true value, but may lead to undesirable offshoot effects. On the other hand, the drift of sensor position is typically a slow process, thus permitting a small parametric value for η.

To recapitulate, adjusting alignment of each object-locating sensor relative to the vehicle coordinate system comprises initially setting each sensor's position (R and r₀) to nominal values. The following steps are repeated. Each object map is compensated based on each sensor's position (R and r₀). Outputs from each of the sensors are fused to determine a series of temporal benchmark positions for the targeted object. A trajectory and associated object map is stored in a circular queue for the fused outputs. When the queues of fused objects have a sufficient amount of data, for each sensor the following actions are executed: the matched object {(r_{fi}, rₐᵢ)|i=1, . . . , N} in the queues is output, wherein r_{fi}, and rₐᵢ denote the positions of the fused object and the sensor observed object, respectively. Eq. 9 is executed to compute corrections β, and Eqs. 10 and 11 are executed to update each sensor's position (R and r₀).

The invention has been described with specific reference to the preferred embodiments and modifications thereto. Further modifications and alterations may occur to others upon reading and understanding the specification. It is intended to include all such modifications and alterations insofar as they come within the scope of the invention.

Having thus described the invention, it is claimed:

1. Article of manufacture, comprising a storage medium having a computer program encoded therein for effecting a method to align one of a plurality of object-locating sensors mounted on a vehicle, the program comprising:
code for establishing initial values for alignments of each of the object-locating sensors relative to a coordinate system for the vehicle;
code for determining a plurality of positions for a target object for each of the object-locating sensors;
code for determining a trajectory for the target object; and,
code for adjusting the alignment of each of the object-locating sensors relative to the coordinate system for the vehicle based upon the trajectory for the target object.

2. The article of manufacture of claim 1, wherein code for establishing initial values for alignments of each of the object-locating sensors relative to a coordinate system for the vehicle comprises establishing values using a manual calibration process.

3. The article of manufacture of claim 1, wherein code for determining a plurality of positions for a target object for each of the object-locating sensors comprises code for determining positions of the target object for each of the object-locating sensors at a series of substantially time-coincident moments occurring over a period of time.

4. The article of manufacture of claim 3, wherein code for determining a trajectory for the target object comprises code for determining a plurality of matched positions of the target object for each of the object-locating sensors at the series of substantially time-coincident moments occurring over the period of time.

5. The article of manufacture of claim 1, wherein code for adjusting the alignment of each of the object-locating sensors relative to the coordinate system for the vehicle based upon the trajectory for the target object further comprises:
code for determining a plurality of matched positions of the target object at a series of substantially time-coincident moments occurring over a period of time;
code for estimating a plurality of corrections using a least-squares method; and,
code for determining an angular alignment of the sensor relative to the vehicle coordinate system.

6. The article of manufacture of claim 5, wherein each matched position of the target object comprises a fused position of the target object, and, a time-coincident sensor-observed position of the target object.

7. The article of manufacture of claim 5, wherein code for estimating a plurality of corrections further comprises code for iteratively executing a least-squares estimation equation.

8. The article of manufacture of claim 5, wherein code for determining an angular alignment of the sensor relative to the vehicle coordinate system further comprises incrementally iteratively correcting the angular alignment of the sensor relative to the vehicle coordinate system.

9. The article of manufacture of claim 1, wherein one of the object-locating sensors comprises a short-range radar subsystem.

10. The article of manufacture of claim 1, wherein one of the object-locating sensors comprises a long-range radar subsystem.

11. The article of manufacture of claim 1, wherein one of the object-locating sensors comprises a forward vision subsystem.

12. Method for aligning one of a plurality of object-locating sensors mounted on a vehicle relative to the vehicle, comprising:
establishing initial values for alignments of each of the object-locating sensors relative to a coordinate system for the vehicle;
determining a plurality of positions for a target object for each of the object-locating sensors;
determining a trajectory for the target object; and,
adjusting the alignment of each of the object-locating sensors relative to the coordinate system for the vehicle based upon the trajectory for the target object.

13. The method of claim 12, wherein the method for aligning one of the plurality of object-locating sensors mounted on the vehicle further comprises aligning one of the object-locating sensors to a coordinate system for the vehicle.

14. The method of claim 13, wherein establishing initial values for the alignments of each of the object-locating sensors relative to the coordinate system for the vehicle comprises establishing initial values for the alignments of each of the object-locating sensors relative to a coordinate system for each sensor.

15. The method of claim 13, wherein establishing initial values for alignments of each of the object-locating sensors relative to a coordinate system for the vehicle comprises establishing values using a manual calibration process.

16. The method of claim 13, wherein determining a plurality of positions for a target object for each of the object-locating sensors relative to a coordinate system for the vehicle comprises determining the plurality of positions of the target object for each of the object-locating sensors at a series of substantially time-coincident moments occurring over a period of time.

17. The method of claim 16, wherein determining a trajectory for the target object comprises determining a plurality of matched positions of the target object for each of the object-locating sensors at the series of substantially time-coincident moments occurring over the period of time.

18. System for locating a target object, comprising: a vehicle equipped with a control system operably connected to a plurality of object-locating sensors each operable to generate a signal output characterizing location of the target object in terms of a range, a time-based change in range, and an angle measured from a coordinate system oriented to the vehicle;
the control system operable to fuse the plurality of signal outputs of the object-locating sensors to locate the target object;
the control system including an algorithm for aligning the signal outputs of each of the object-locating sensors, the algorithm comprising:
a) code for establishing initial values for alignments of each of the object-locating sensors relative to a coordinate system for the vehicle;
b) code for determining a plurality of positions for the target object for each of the object-locating sensors;
c) code for determining a trajectory for the target object; and,
d) code for adjusting the alignment of each of the object-locating sensors relative to the coordinate system for the vehicle based upon the trajectory for the target object.
